(19) United States
(12) Patent Application Publication
(10) Pub. No.: US 2013/0317992 A1
(43) Pub. Date: Nov. 28, 2013

(54) METHOD OF INTERNET REAL-TIME CUSTOMER SERVICE

(71) Applicant: CHIEN-CHUNG YUEH, NEW TAIPEI CITY (TW)

(72) Inventor: CHIEN-CHUNG YUEH, NEW TAIPEI CITY (TW)

(21) Appl. No.: 13/480,818

(22) Filed: May 25, 2012

(51) Int. Cl. G06Q 10/00

(52) U.S. Cl. 705/304

(57) ABSTRACT

The present invention provides a method of Internet real-time customer service, including the steps of: providing an online customer service system connected to Internet; providing an exclusive login data to the website operator registering to the online customer service system; for customer service staff of website operator using the exclusive login data to log in to the online customer service system for the online customer service system to enable customer service staff of website operator able to monitor the website; and when visitor visiting the website, the online customer service system providing a plurality of interaction channels between the customer service staff and the visitor as the basis of interaction so that the customer service staff and the visitor able to select from a plurality of interaction channels for interacting with each other.

### BACKGROUND OF THE INVENTION

1. Field of the Invention

The present invention relates to the field of customer service techniques, and in particular to a method of real-time customer service applicable to Internet.

2. The Related Arts

The conventional website consumption is often oriented toward the consumer in a unidirectional manner. If the consumer (namely a visitor to the website) does not initiate contact with website operator, the website operator has no way to obtain the information of the consumer. As most consumers leave the website after browsing, the website operator has no opportunity or other means to provide appropriate assistance or answer in a timely fashion. This lack of flexibility makes the majority of potential consumers left unsatisfied and renders the website mostly inactive.

It is, therefore, imperative to devise a method to allow the website operator to initiate interaction with visitors who visit the website and browse the web pages so as to provide assistance, answer questions and offer explanation and services.

### SUMMARY OF THE INVENTION

An object of the present invention is to provide a method of Internet real-time customer service by providing an online customer service system and a plurality of related steps so that a website operator can initiate contact with the website visitor to provide interactions for assistance and services, whereby the website can be invigorated to assist the website operator to turn a potential customer (a website visitor) into an actual customer.

To achieve the above object, the present invention provides a method of Internet real-time customer service, comprising the steps of: (a) providing an online customer service system connected to Internet; (b) providing exclusive login data to a website operator registering to the online customer service system; (c) customer service staff of the website operator using the exclusive login data to log in to the online customer service system for the online customer service system to enable the customer service staff of the website operator to monitor the website; and (d) when a visitor visits the website, the online customer service system providing a plurality of interaction channels between the customer service staff and the visitor as the basis of interaction so as to enable the customer service staff and the visitor to select from a plurality of interaction channels for interacting with each other.

In this manner, the website operator and the customer service staff can initiate contact with the website visitor to provide interactions for assistance and services. In this manner, the website can be invigorated to assist the website operator to turn a potential customer (a website visitor) into an actual customer.

To make the technical solution of the embodiments according to the present invention clearly understood, a brief description of the drawings that are necessary for the illustration of the embodiments will be given as follows. It is understood that the drawings and the embodiments are only for illustrative purpose, instead of restrictive.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of an embodiment of the present invention; and

FIG. 2 is a flowchart of the method according to the present invention.

### DETAILED DESCRIPTION OF THE PREFERRED EMBODIMENTS

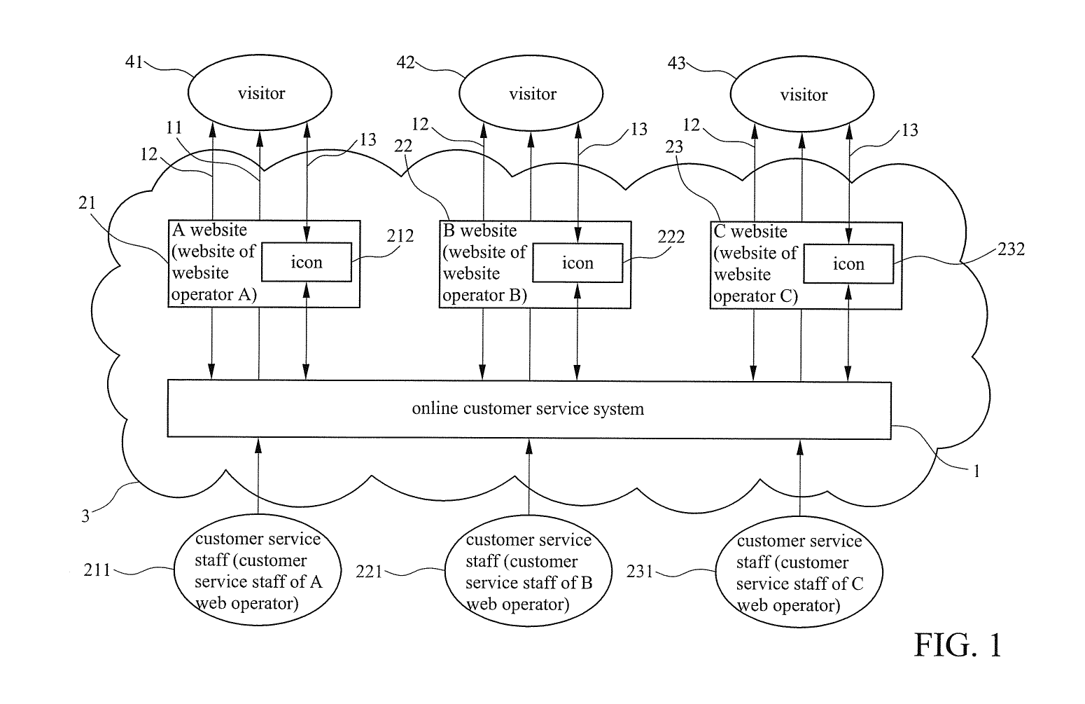

The present invention provides a method of Internet real-time customer service. FIG. 1 shows, for illustrative purpose, an online customer service system 1, which is capable of supporting a plurality of website operators to log in simultaneously, as well as supporting a plurality of customer service staff from a single website operator to log in to interact with visitors, or supporting a plurality of visitors to interact with the same customer service staff from a website operator. The present invention does not impose any restriction in this respect.

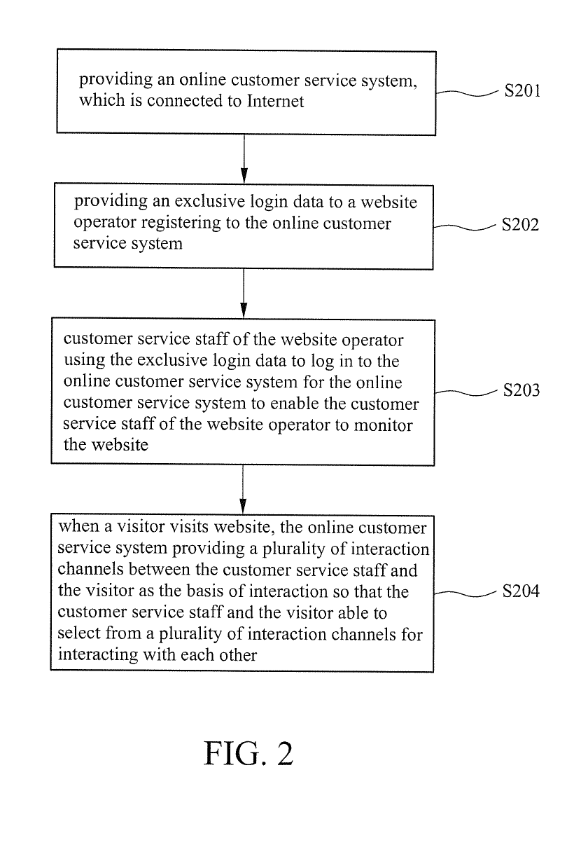

Referring to FIGS. 1 and 2, the method of Internet real-time customer service comprises the following steps:

S201: providing an online customer service system 1, which is connected to Internet 3.

S202: providing an exclusive login data (not marked with a reference numeral but will be described in details later) to a website operator registering to the online customer service system 1, wherein the exclusive login data can be a web page editing string, exclusive to a single website operator. After the website operator adds the web page editing string to the website operator's own source editing string of web page (for example, to the second last line of the source editing string, and remaining a separate line), the website operator logs in and connects to online customer service system 1 for the first time. The online customer service system 1 enables the customer service staff of the website to monitor the website, and the website operator can use the web page to directly log in to the online customer service system 1 subsequently, for example, by inputting account and password given during registration. The second and subsequent logins to the online customer service system 1 can all be conducted in this manner. In addition to the web page login, an executable file (not marked with a reference numeral) can be generated when the website operator logs in and connects to the online customer service system 1 for the first time. The executable file is passed to the website operator, and the website operator can log in to the online customer service system 1 by executing the executable file.

S203: the customer service staff of the website operator (website operators A, B, C and customer services staff 211, 221, 231) using the exclusive login data to log in and connect to the online customer service system 1 for the first time so that the online customer service system 1 can enable the customer service staff of the website operator to monitor the activities on the websites (A website 21, B website 22, C website 23 from website operators A, B, C), for example, to know any visitor browsing the website and which page the visitor currently browsing, and so on.

S204: when visitors visit the website (A website 21, B website 22, C website 23) from Internet 3, the online customer service system 1 provides a plurality of interaction channels (first interaction channel 11, second interaction channel 12, third interaction channel 13) between the customer service staff and the visitors 41-43 as the basis of interaction so that the customer service staff and the visitor can select from the plurality of interaction channels 11-13 for interacting with each other.

To simplify the description, the following description uses the website operator A (A website 21, customer service staff 211 of website operator A) as an exemplary embodiment.

According to the present embodiment, the interaction channels include a first interaction channel 11 and a second interaction channel 12. The first interaction channel 11 is for the customer service staff 211 of the website operator A to initiate interaction with a visitor 41 of A website 21 by issuing an interaction invitation. The interaction invitation is issued through the format of dialog box to the visitor 41, and the online customer service system 1 waits for the response from the visitor 41. When the visitor 41 agrees to accept the interaction invitation, the online customer service system 1 automatically switches to the second interaction channel 12, and the second interaction channel 12 is for the customer service staff 211 of the website operator A to interact with the visitor 41. The interaction includes a plurality of interaction mechanisms, and the customer service staff 211 of the website operator A and the visitor 41 can select at least one from the plurality of interaction mechanisms to conduct interaction.

The interaction channels in the method of Internet real-time customer service of the present invention can further include a third interaction channel 13. The third interaction channel 13 is established in A website 21 of the website operator A by the online customer service system 1 in a format of an icon 212. When the visitor 41 visiting A website 21 clicks on the icon 212, the online customer service system 1 allows the customer service staff 211 and the visitor 41 to conduct interaction. The interaction includes a plurality of interaction mechanisms, and the customer service staff 211 of the website operator A and the visitor 41 can select at least one from the plurality of interaction mechanisms to conduct interaction. The third interaction channels 13 for B website 22 and C website 23 are also established in B website 22 and C website 23 by the online customer service system 1 in a format of an icon 222, 232, respectively.

The aforementioned interaction mechanisms include: text, audio, image, video and file transfer. The customer service staff and the visitor can select one or more from the plurality of interaction mechanisms to conduct interaction.

In addition, the online customer service system 1 further includes at least a database (not shown). The online customer service system 1 can record and store the IP address of the website visitor and the interaction contents through the interaction mechanism to the database.

The customer service staff 211, 221, 231 of the present invention can log in to and use the online customer service system 1 through all types of computers, such as notebook computer or desktop computer. The visitors 41, 42, 43 can visit the website through any electronic device able to connect to Internet, such as, desktop computer, notebook computer, tablet computer, or smart phone. The customer service staff can also interact with the visitors through smart phones.

When is use, the online customer service system 1 provides the following functions to the customer service staff: visitor dialog, internal dialog among customer service staff, customer management, customer service management, accesses to the record center of aforementioned database, and so on. When the visitor 41 visits A website 21 of website operator A, the online customer service system 1 sends a message indicating visitor arrival to the customer service staff 211. Therefore, the customer service staff 211 can send an inquiry message through the first interaction channel 11 to the visitor 41, and the inquiry message will appear on the electronic device of the visitor 41 in a dialog box, with contents, such as, “Dear Customer, how may I help you? ‘Start Conversation’ or ‘Maybe Next Time’”. By initiating the interaction, when the visitor 41 selects ‘Start Conversation’, the system switches to the second interaction channel 12 so that the customer service staff 211 and the visitor 41 can start to interact. The interaction includes: text, audio, image, video and file transfer. When the customer service staff 211 is temporarily unavailable, the online customer service system 1 also provides the function of settable online status, such as, online or temporarily unavailable, so that the visitor 41 can act accordingly, such as, leaving message to the customer service staff 211 for the customer service staff 211 to respond when the customer service staff 211 becomes available again. The customer service staff 211 can edit and store visitor data, for example, editing name to the visitor 41 showing only IP address, editing and assigning to different groups, editing phone number, email address, and so on. Also, a plurality of customer service staff from the same website operator can conduct internal dialog or meeting through the online customer service system 1.

In summary, the method of Internet real-time customer service of the present invention provides the features of: by providing an online customer service system 1 so that website operators A, B, C can initiate interaction with visitors 41, 42, 43 visiting websites (A website 21, B website 22, C website 23) to offer assistance, answer, in-depth explanation and services so as to achieve invigorating the website to change the potential customer into actual customers. In addition, customer service staff 211, 221, 231 of website operators A, B, C can also use wireless access to internet of mobile phone to the connect to online customer service system 1 to interact with visitors.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A method of Internet real-time customer service, which comprises:
providing an online customer service system, which is connected to Internet;
providing an exclusive login data to a website operator registering to the online customer service system;
customer service staff of the website operator using the exclusive login data to log in to the online customer service system for the online customer service system to enable the customer service staff of the website operator to monitor the website; and
when a visitor visits website, the online customer service system providing a plurality of interaction channels between the customer service staff and the visitor as the basis of interaction so that the customer service staff and the visitor able to select from a plurality of interaction channels for interacting with each other.

2. The method as claimed in claim 1, wherein the plurality of interaction channels further comprises a first interaction channel and a second interaction channel; the first interaction channel is for the customer service staff to initiate sending an interaction invitation to the visitor to the website;
the interaction invitation appears as a dialog box to the visitor; the online customer service system waits for the visitor to respond; when the visitor accepts the interaction invitation, the online customer service system automatically switches to the second interaction channel; the second interaction channel is for customer service staff and visitor to conduct interaction; the interaction further comprises a plurality of interaction mechanisms; the customer service staff and visitor can select at least one from the plurality of interaction mechanism to conduct interaction.

3. The method as claimed in claim 1, wherein the plurality of interaction channels further comprises a third interaction channel; the third interaction channel is established in the website by the online customer service system in the format of an icon; when the visitor visiting the website clicks on the icon, the online customer service system allows the customer service staff and the visitor to conduct interaction; the interaction further comprises a plurality of interaction mechanisms; the customer service staff and visitor can select at least one from the plurality of interaction mechanism to conduct interaction.

4. The method as claimed in claim 2, wherein the plurality of interaction mechanisms further comprises: text, audio, image, video and file transfer.

5. The method as claimed in claim 3, wherein the plurality of interaction mechanisms further comprises: text, audio, image, video and file transfer.

6. The method as claimed in claim 1, wherein the exclusive login data is a web page editing string; after the website operator adds the web page editing string to the website operator's own source editing string of web page, the website operator logs in and connects to the online customer service system for the first time; the online customer service system enables the customer service staff of the website to monitor the website, and the website operator can use web page to directly log in to the online customer service system subsequently.

7. The method as claimed in claim 6, wherein an executable file is generated when the website operator logs in and connects to the online customer service system for the first time; the executable file is passed to the website operator, and the website operator can log in to the online customer service system by executing the executable file.

8. The method as claimed in claim 1, wherein the online customer service system further comprises at least a database; the online customer service system can record and store IP address of the visitor when visiting the website and interaction contents through the interaction mechanism to the database.
